(19) United States
(12) Patent Application Publication
(10) Pub. No.: US 2019/0058506 A1
(43) Pub. Date: Feb. 21, 2019

(54) WIRELESS POWER TRANSMISSION CONTROL METHOD AND APPARATUS

(71) Applicant: LG INNOTEK CO., LTD., Seoul (KR)

(72) Inventor: Yun Bok LEE, Seoul (KR)

(73) Assignee: LG INNOTEK CO., LTD., Seoul (KR)

(21) Appl. No.: 16/085,343

(22) PCT Filed: Feb. 23, 2017
(86) PCT No.: PCT/KR2017/001970

§ 371 Date: Sep. 14, 2018

(30) Foreign Application Priority Data
Mar. 15, 2016 (KR) 10-2016-0030815

(51) Int. Cl. H04B 5/00; H02J 7/02; H02J 50/10; H02J 50/12; H02J 50/80

(52) U.S. Cl. CPC H04B 5/0037; H02J 7/025; H02J 50/80; H02J 50/12; H02J 50/10

(57) ABSTRACT

The present invention relates to a method and an apparatus capable of recognizing a wireless power reception apparatus. A wireless power transmission control method according to one embodiment of the present invention comprises: a search step for searching for a device through an identifier received using wireless communication; a selection step for selecting an identifier to be used to transmit wireless power among identifiers of the devices obtained by the search; and a control step for determining whether to activate a wireless power transmitter, according to a charging activation indicator configured to correspond to the selected identifier, wherein the identifier of the device may be selected on the basis of pre-collected wireless charging history information or through a user interface.

### TECHNICAL FIELD

Embodiments relate to wireless power transmission and, more particularly, to a control method and apparatus of a wireless power transmitter.

### BACKGROUND ART

A portable terminal such as a portable phone and a laptop computer includes a battery for storing power and a circuit for charging and discharging the battery. To charge the battery of the terminal, power needs to be supplied from an external charger.

In general, an example of an electrical connection method between a battery and a charging device for charging the battery with power is a terminal supply method of receiving commercial power, converting the commercial power into a voltage and current corresponding to the battery, and supplying electric energy to the battery through a terminal of the corresponding battery. The terminal supply method is accompanied by use of a physical cable or wire. Accordingly, when many equipments of the terminal supply method are used, many cables occupy a significant working space, it is difficult to arrange the cables, and an outer appearance thereof is poor. The terminal supply method has a problem in terms of an instantaneous discharge phenomenon due to different potential differences between terminals, damage and fire due to impurities, natural discharge, reduction in a lifetime of a battery, degradation in battery performance, and so on.

Recently, to overcome the problem, a charging system (hereinafter, referred to as a “wireless charging system”) using a method of wirelessly transmitting power and control methods thereof have been proposed. In the past, the wireless charging system is not basically installed in some terminals and consumers need to separately purchase separate wireless charging receiver accessories and, thus, a demand for the wireless charging system is low, but the number of users of wireless charging is expected to be remarkably increased and, in the future, a manufacturer of a terminal is also expected to basically install a wireless charging function.

In general, a wireless charging system includes a wireless power transmitter for supplying electric energy in a wireless power transmitting manner and a wireless power receiver for receiving the electric energy supplied from the wireless power transmitter to charge a battery with the electric energy.

Such a wireless power transmitter is generally put on a desk, a table, or the like while being used and is also developed for a vehicle, is applied to the vehicle, and is used in the vehicle. A wireless power transmitter installed in a vehicle is provided in the form of a holder for stably fixation and hold.

A wireless power transmitter installed in a vehicle is configured to be activated when the vehicle is turned on (Default ON) or, on the other hand, is configured to be deactivated even if the vehicle is turned (Default OFF).

When the wireless power transmitter is configured to be activated at a time point at which the vehicle is turned on (Default ON), if a user does not use a wireless power system (e.g., if a terminal carried by a driver is a terminal without a wireless power receiver), the user has inconvenience of directly configuring a wireless power system to be deactivated through a user interface and, even if the wireless power system is not used until the wireless power system is configured to be deactivated, there is a problem in term of wasting power by the wireless power transmitter. When a terminal that is not applied to a wireless charging system or an object formed of a steel material is put on an activated wireless power transmitter, there is a problem in that an allophone “tic tac tic tac” is continuously generated.

On the other hand, in a situation in which a wireless power system is configured to be deactivated even if a vehicle is turned on (Default OFF), a user also has inconvenience of directly setting the wireless power system to be deactivated to use the wireless power system.

Accordingly, there is a need for a method of actively controlling whether a wireless power transmitter is activated.

### DISCLOSURE

### Technical Problem

Embodiments provide a wireless power transmission control method and apparatus.

Embodiments provide a wireless power transmission control method and apparatus for recognizing a wireless power receiver carried by a driver to automatically control whether a wireless power transmitter is activated, via wireless communication.

It is to be understood that both the foregoing general description and the following detailed description of the embodiments are exemplary and explanatory and are intended to provide further explanation of the embodiments as claimed.

### Technical Solution

In one embodiment, a wireless power transmission control method may include searching for devices through an identifier received using wireless communication, selecting an identifier to which power is wirelessly transmitted among identifiers of the retrieved devices, and controlling and determining whether a wireless power transmitter is activated, according to a charging activation indicator configured to correspond to the selected identifier.

In some embodiments, the selecting may include selecting the identifier of the device based on pre-collected.

In some embodiments, the selecting may include, when the identifier is not retrieved in a plural number, selecting the retrieved identifier as the identifier to which power is wirelessly transmitted.

In some embodiments, the wireless power transmission control method may further include, when the charging activation indicator is not stored, receiving the charging activation indicator, and storing the charging activation indicator corresponding to the selected first identifier.

In some embodiments, the selecting may include, when the identifier is retrieved in a plural number, selecting the identifier according to pre-stored priority based on the wireless charging history information.

In some embodiments, the priority may be configured in the order from a device with the largest number of times that the wireless communication is connected for a unit time.

In some embodiments, the priority may be configured in the order from a device corresponding to the identifier that is the most recently selected.

In some embodiments, the searching may include, when the retrieved device is not present, maintaining the wireless power transmitter in a deactivated state or deactivating a pre-activated wireless power transmitter.

In some embodiments, the wireless communication may be Bluetooth communication or wireless LAN communication.

In another embodiment, a wireless power transmission control apparatus may include a communication unit configured to receive an identifier from a device, and a controller configured to select an identifier to which power is wirelessly transmitted among retrieved identifiers of the device and to determine whether a wireless power transmitter is activated according to a charging activation indicator configured to correspond to the selected identifier, wherein the controller may select the identifier of the device based on pre-collected wireless charging history information or through a user interface.

In some embodiments, when the identifier is not retrieved in a plural number, the controller may select the retrieved identifier as the identifier to which power is wirelessly transmitted.

In some embodiments, the wireless power transmission control apparatus may further include an input unit configured to, when the charging activation indicator is not stored in a memory, receive the charging activation indicator, and a memory configured to store the charging activation indicator corresponding to the selected first identifier.

In some embodiments, when the identifier is retrieved in a plural number, the controller may select the identifier according to pre-stored priority based on the wireless charging history information.

In some embodiments, the priority may be configured in the order from a device with the largest number of times that the wireless communication is connected for a unit time.

In some embodiments, the priority may be configured in the order from a device corresponding to the identifier that is the most recently selected.

In some embodiments, when the retrieved device is not present, the controller may maintain the wireless power transmitter in a deactivated state or may deactivate a pre-activated wireless power transmitter.

In some embodiments, the wireless communication may be Bluetooth communication or wireless LAN communication.

In some embodiments, a computer readable recording medium may have recorded thereon a program for executing the method.

### Advantageous Effects

A wireless power transmission control method and apparatus according to exemplary embodiments may have the following effects.

First, according to the embodiments, a wireless power receiver may be recognized and whether a wireless power transmitter is activated may be automatically controlled, thereby overcoming driver inconvenience of directly configuring a wireless power transmitter to be activated/deactivated (ON/OFF).

Second, according to the embodiments, a wireless power transmitter may be activated only when a wireless power receiver needs to be charged, thereby preventing power from wasting by the wireless power transmitter.

Third, according to the embodiments, a user equipment (UE) that does not include a wireless power receiver may be prevented from being damaged or a wireless power transceiver may be prevented from being damaged due to other impurities, overloading, or heating.

It will be appreciated by persons skilled in the art that that the effects that could be achieved with the embodiments are not limited to what has been particularly described hereinabove and other advantages of the embodiments will be more clearly understood from the following detailed description taken in conjunction with the accompanying drawings.

### DESCRIPTION OF DRAWINGS

The accompanying drawings, which are included to provide a further understanding of the embodiments, illustrate embodiments of the embodiments and together with the description serve to explain the principle of the embodiments.

In the drawings:

FIG. 1 is a diagram for explanation of a wireless charging system according to an embodiment;

FIG. 2 is a flowchart for explanation of a wireless power transmission control method according to an embodiment;

FIG. 3 is a flowchart for explanation of a radio power transmission control method using priority according to an embodiment;

FIG. 4 is a flowchart for explanation of a method of recognizing a wireless power reception apparatus according to an embodiment; and

FIG. 5 is a diagram for explanation of a configuration of a wireless power transmission control apparatus according to an embodiment.

### BEST MODE

A wireless power transmission control method according to an embodiment may include searching for a device through an identifier received using wireless communication, selecting an identifier for wirelessly transmitting power among identifiers of the retrieved device, and controlling and determining whether a wireless power transmitter is activated according to a charging activation indicator configured to correspond to the selected identifier.

### Mode for Invention

Reference will now be made in detail to the embodiments, examples of which are illustrated in the accompanying drawings. The suffixes “module” and “unit” of elements herein are used for convenience of description and thus can be used interchangeably and do not have any distinguishable meanings or functions.

Although all elements constituting the embodiments are described as integrated into a single one or to be operated as a single one, the embodiments is not necessarily limited to such embodiments. According to embodiments, all of the elements may be selectively integrated into one or more and be operated as one or more within the object and the scope of the embodiments. Each of the elements may be implemented as independent hardware. Alternatively, some or all of the elements may be selectively combined into a computer program having a program module performing some or all functions combined in one or more pieces of hardware. A plurality of codes and code segments constituting the computer program may be easily understood by those skilled in the art to which the embodiments pertain. The computer program may be stored in computer readable media such that the computer program is read and executed by a computer to implement the embodiments. Computer program storage media may include magnetic recording media, optical recording media, and carrier wave media.

In description of exemplary embodiments, it will be understood that, when an element is referred to as being “on” or “under” and “before” or “after” another element, the element can be directly on another element or intervening elements may be present.

The term “comprises”, “includes”, or “has” described herein should be interpreted not to exclude other elements but to further include such other elements since the corresponding elements may be included unless mentioned otherwise. All terms including technical or scientific terms have the same meanings as generally understood by a person having ordinary skill in the art to which the embodiments pertain unless mentioned otherwise. Generally used terms, such as terms defined in a dictionary, should be interpreted to coincide with meanings of the related art from the context. Unless differently defined in the embodiments, such terms should not be interpreted in an ideal or excessively formal manner.

It will be understood that, although the terms first, second, A, B, (a), (b), etc. may be used herein to describe various elements of the embodiments, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In the description of the embodiments, certain detailed explanations of related art are omitted when it is deemed that they may unnecessarily obscure the essence of the embodiments.

In the description of the embodiments, a device for wirelessly transmitting power in a wireless power charging system is interchangeably used with a wireless power transmitter, a wireless power transmission apparatus, a wireless power transmission apparatus, a wireless power transmitter, a transmission end, a transmitter, a transmission apparatus, a transmission side, a wireless power transmission apparatus, a wireless power transmitter, a wireless charging device, or the like, for convenience of description. In addition, a device for wirelessly receiving power from a wireless power transmission apparatus is interchangeably used with a wireless power reception apparatus, a wireless power receiver, a wireless power reception apparatus, a wireless power receiver, a reception terminal, a reception side, a reception apparatus, a receiver terminal, or the like, for convenience of description.

A wireless charging device according to the embodiments may be configured in the form of a pad, a holder, an access point (AP), a small eNB, a stand, a ceiling installation type, a wall-mount type, or the like or one transmitter may also transmit power to a plurality of wireless power reception apparatuses.

To this end, a wireless power transmitter may provide at least one wireless power transmission method, for example, an electromagnetic induction method, an electromagnetic resonance method, or the like.

For example, a wireless power transmission method may use various wireless power transmission standards based on an electromagnetic induction method of generating a magnetic field from a power transmission end coil to perform charge using an electromagnetic induction principle whereby electricity is induced from a coil of a reception end due to influence of the magnetic field. Here, the wireless power transmission standard of the electromagnetic induction method may include a wireless charging technology of an electromagnetic induction method defined in the wireless power consortium (WPC) and/or the wireless power consortium (PMA).

As another example, the wireless power transmission method may also use an electromagnetic resonance method of transmitting power to a wireless power receiver positioned within a short distance by synchronizing a magnetic field generated in a transmission coil of the wireless power transmitter with a specific resonance frequency. For example, the electromagnetic resonance method may include a wireless charging technology defined in the alliance for wireless power (A4WP) standard organization as a wireless charging technology standard organization.

As another example, the wireless power transmission method may also use a radio frequency (RF) wireless power transmission method of loading low-power energy to an RF signal and transmitting power to a wireless power receiver positioned at a long distance.

As another example of the embodiments, the wireless power transmitter according the embodiments may be designed to support at least two or more of wireless power transmission methods among the aforementioned electromagnetic induction method, electromagnetic resonance method, and RF wireless power transmission method.

In this case, the wireless power transmitter may determine a wireless power transmission method to be adaptively used for a corresponding wireless power receiver based on a type, state, power requirements, and so on of the wireless power receiver as well as the wireless power transmission method to be supportable by the wireless power transmitter and the wireless power receiver.

A wireless power receiver according to an embodiment may include at least one wireless power transmission method and may simultaneously and wirelessly receive power from two or more wireless power transmitters. Here, the wireless power transmission method may include at least one of the electromagnetic induction method, the electromagnetic resonance method, and the RF wireless power transmission method.

A terminal according to the embodiments may be used in a small electronic device such as a mobile phone, a smartphone, a laptop computer, a digital broadcast terminal, personal digital assistants (PDA), a portable multimedia player (PMP), a navigation device, an MP3 player, an electric toothbrush, an electronic tag, a lighting device, a remote controller, or a float but is not limited and, for example, the terminal may be any mobile device (hereinafter, referred to as a “device”) including a wireless power reception element installed therein to charge a battery or may be interchangeably used with the term of a user equipment (UE) or a device. A wireless power receiver according to another embodiment may also be mounted on a vehicle, an unmanned aerial vehicle, an air drone, or the like.

In general, a wireless power transmitter and a wireless power receiver which configure a wireless power system may exchange a control signal or information via in-band communication or Bluetooth low energy (BLE) communication. Here, in-band communication and BLE communication may be performed using a pulse width modulation method, a frequency modulation method, a phase modulation method, an amplitude modulation method, an amplitude and phase modulation method, or the like. For example, the wireless power receiver may perform ON/OFF switching on current induced through a reception coil in a predetermined pattern to generate a feedback signal and, thus, may transmit various control signals and information to the wireless power transmitter. The information transmitted by the wireless power receiver may include various state information items including reception power intensity information. In this case, the wireless power transmitter may calculate charging efficiency or power transmission efficiency based on the reception power intensity information.

In-band (BLE) communication and power transmission of the wireless power transmitter and the wireless power receiver may be performed in a state in which the wireless power transmitter is activated. A wireless power transmitter installed in a vehicle may be pre-configured with respect to whether the wireless power transmitter is activated when the vehicle is released (Default ON/OFF) or, after the vehicle is released, a driver may manually configure whether wireless power transmitter is activated, via predetermined menu setting. For example, the driver may configure whether the wireless power transmitter is activated, through selection of a predetermined menu in a vehicle head unit but this is merely an embodiment and, as another example, the driver may connect communication with the vehicle head unit through a predetermined application installed on the their smartphone and may also configure whether the wireless power transmitter is activated, through selection of a predetermined menu on an application.

The embodiments may provide a wireless power transmission control method and apparatus, for recognizing a terminal including a wireless power receiver and automatically configuring whether a wireless power transmitter is activated for each recognized terminal, to actively control whether the wireless power transmitter is activated.

According to an embodiment, a wireless power transmission apparatus may use wireless communication to recognize a terminal including a wireless power receiver. A wireless power transmission control apparatus may be installed in a vehicle and, when a driver is in a vehicle, the wireless power transmission control apparatus needs to control activate the wireless power transmitter.

In other words, wireless communication according to the embodiments as wireless communication performed in a vehicle may be short-distance wireless communication (e.g., Bluetooth), near field communication (NFC), wireless fidelity (WiFi), or the like.

According to an embodiment, wireless communication between the wireless power transmission control apparatus and the wireless power receiver may use a separate different communication channel from a wireless communication channel for control of power transmission between the wireless power transmitter and the wireless power receiver, for example, an in-band (BLE) communication channel. As another example, when a wireless communication channel for control of power transmission between the wireless power transmitter and the wireless power receiver is an out-band communication channel such as Bluetooth low energy (BLE) communication, a communication channel for identifying whether a wireless power receiver is a receiver that needs to activate a wireless power transmitter, by a wireless power transmission control apparatus, may be a different communication channel from the out-band communication channel.

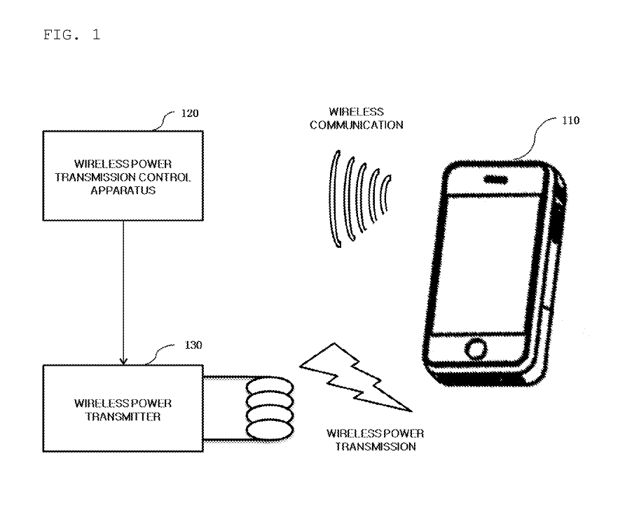

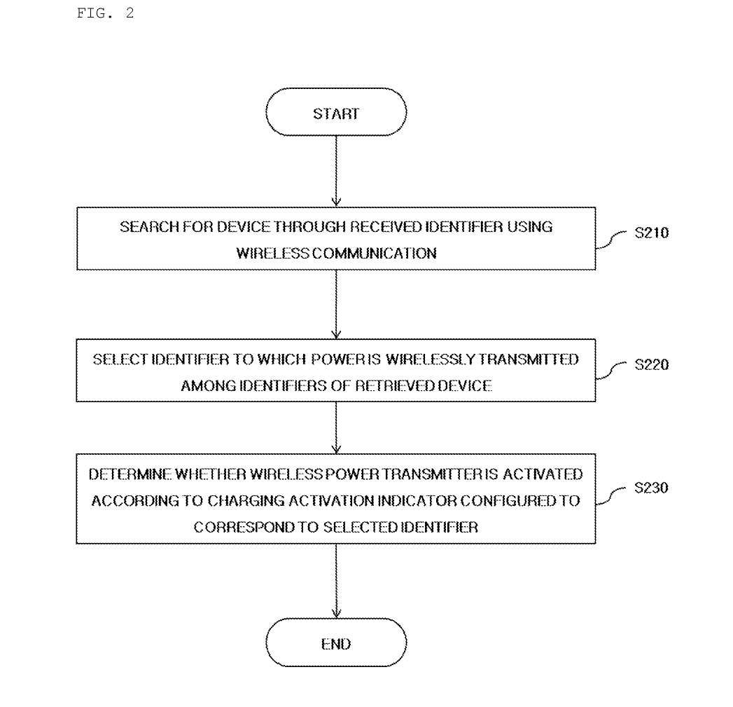

A configuration of a wireless charging system according to an embodiment is described with reference to FIG. 1. A method of recognizing a wireless power receiver based on the above configuration is described with reference to FIGS. 2, 3, and 4.

FIG. 1 is a diagram for explanation of a wireless charging system according to an embodiment.

Referring to FIG. 1, the wireless charging system may include a user equipment (UE) 110 including a wireless power receiver, a wireless power transmission control apparatus 120, and a wireless power transmitter 130.

Components shown in FIG. 1 are not necessary and, thus, greater or fewer components than in FIG. 1 may configure the wireless charging system.

Hereinafter, the components are described in detail.

The UE 110 may be a terminal carried when a driver gets into a vehicle and may include a wireless power receiver.

The wireless power transmission control apparatus 120 and the wireless power transmitter 130 may configure a separate system for wireless charging but this is merely an embodiment and, as another example, when the wireless power transmission control apparatus 120 is installed in a vehicle, the wireless power transmission control apparatus 120 may be included in a head unit (H/U) and may be operated and, when the wireless power transmission control apparatus 120 is included in the H/U and is operated, various functions of the H/U may be used. The wireless power transmission control apparatus 120 may also be configured to be operatively associated with an H/U of a vehicle.

In general, a vehicle head unit (hereinafter, referred to as a head unit) may include a wireless communication module such as Bluetooth, a vehicle communication module such as CAN communication, an input module having a user interface, an output module such as a display, a memory, a power source, and an audio/video/navigation (AVN) module.

A function of a head unit having a wireless communication function such as Bluetooth is automatically turned on when a vehicle is turned on and, thus, the head unit becomes in a standby state for wireless communication connection.

A driver may perform a wireless communication connection operation via predetermined menu setting in the UE 110 including the head unit and the wireless power receiver.

According to an embodiment, wireless communication between the head unit and the UE 110 may be Bluetooth communication but is not limited thereto. When a vehicle is turned on by a user to supply power to the vehicle (i.e., ACC ON) and a vehicle system is prepared, the head unit may automatically initiate a Bluetooth pairing procedure. In this case, the head unit may attempt pairing with a predetermined or pre-registered UE including a wireless power receiver. A predetermined user interface image indicating that connection with a specific device is being attempted may be configured and displayed on a display screen of the head unit. The vehicle head unit may configure and display a predetermined user interface image (hereinafter, referred to as a “device registration selection image” for convenience of description) including a menu for registration of a user device or for selection of any one of pre-registered user devices.

In this case, the user may determine the UE 110 as a pairing target along with menu selection on the device registration selection image. A predetermined guidance message indicating that a Bluetooth function of a wireless power receiver as a connection target is activated may be displayed on the display screen of the head unit.

When the Bluetooth function of the wireless power receiver is activated by the user, the wireless power receiver may search for surrounding devices to be Bluetooth-paired and may display the search result on a screen.

As the search result, when the user selects their vehicle on the screen, the wireless power transmission control apparatus may transmit a connection request signal to the selected vehicle. In this case, a user device screen may display a predetermined secret key input image for receiving a secret key value corresponding to the selected vehicle. Then, upon receiving the connection request signal from the user device, the head unit may display the vehicle information and secret key value on the screen.

The user device may receive the secret key value on the secret key input screen and transmit the secret key value to the vehicle head unit and, when the received secret key value is the same as a secret key value thereof, the vehicle head unit may transmit a predetermined authentication completion message indicating that the connection request is completely authenticated, to the user device.

The wireless power transmission control apparatus 120 may receive an identifier of a device by searching for devices to attempt Bluetooth pairing as an embodiment of wireless communication by the UE 110. Upon completely receiving the identifier, the wireless power transmission control apparatus 120 may check an identifier corresponding to the UE 110 and may check a charging activation indicator configured for the identifier.

In this case, the identifier corresponding to the UE 110 may be stored in a memory of the wireless power transmission control apparatus 120, and the memory may store the identifier and a time point for receiving the identifier as wireless charging history information.

The charging activation indicator configured to correspond to the identifier may be setting information for determining whether the wireless power transmitter 130 is activated and, in the case of the UE 110 that first transmits the identifier to the UE 110 using wireless communication, activation of the wireless power transmitter 130 installed in the corresponding vehicle needs to be configured, with respect to the corresponding UE.

Then, when the identifier is transmitted to the wireless power transmission control apparatus 120 using the same UE 110, the wireless power transmission control apparatus 120 may control the pre-configured charging activation indicator to automatically activate or deactivate the wireless power transmitter by a preconfigured charging activation indicator.

Hereinafter, a method of controlling whether the wireless power transmission control apparatus 120 is activated when the wireless power transmission control apparatus 120 searches for a plurality of UEs 110 is described.

FIG. 2 is a flowchart for explanation of a wireless power transmission control method according to an embodiment.

Referring to FIG. 2, the wireless power transmission control apparatus 120 may search for a device through the received identifier via wireless communication (S210).

The wireless power transmission control apparatus 120 may use wireless communication with the UE 110 to search for the UE and, in this case, wireless communication may be any one of Bluetooth communication, WiFi communication, near field communication (NFC) communication, Zigbee communication, unltrawideband (UWB) communication, radio frequency identification (RFID) communication, and IrDA communication but the embodiments are not limited thereto. In detail, in the case of Bluetooth communication, wireless communication for searching for devices by attempting pairing may be used.

The wireless power transmission control apparatus 120 may select an identifier to which power is wirelessly transmitted among identifiers of the retrieved devices (S220).

When the number of received identifiers is one, the wireless power transmission control apparatus 120 may determine whether the wireless power transmitter is activated according to the charging activation indicator configured to correspond to the identifier.

However, the plurality of identifiers are received, the wireless power transmission control apparatus 120 may select an identifier according to preconfigured priority based on pre-collected wireless charging history information.

The wireless power transmission control apparatus 120 may determine whether the wireless power transmitter is activated, according to the charging activation indicator pre-configured to correspond to the selected identifier (S230).

The wireless power transmission control apparatus 120 may generate and transmit a signal for control of whether the wireless power transmitter is activated, to the wireless power transmitter via vehicle communication such as CAN. The wireless power transmitter 130 may control whether the wireless power transmitter is activated, according to a control signal received from the wireless power transmission control apparatus 120.

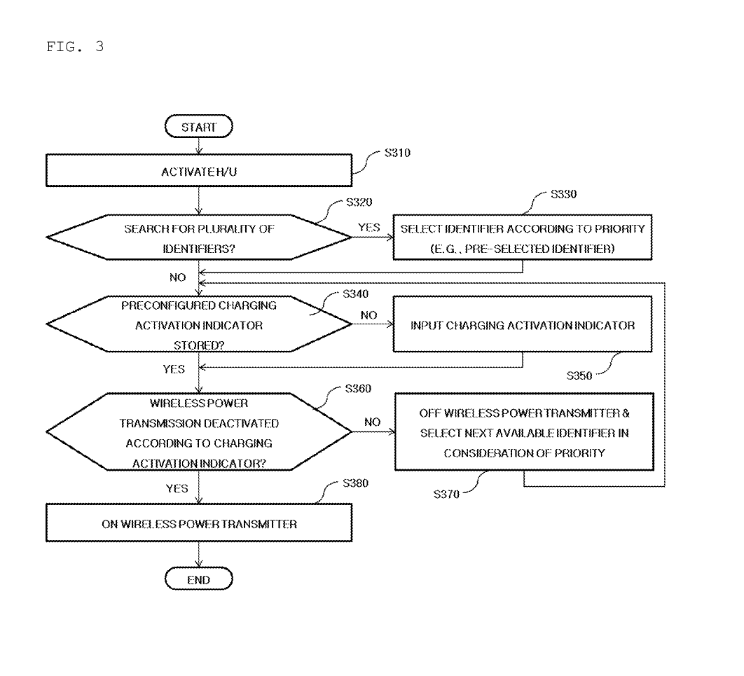

FIG. 3 is a flowchart for explanation of a radio power transmission control method using priority according to an embodiment.

Referring to FIG. 3, the wireless power transmission control apparatus 120 may be included in a head unit.

When the head unit is activated by turning on a vehicle (S310), the wireless power transmission control apparatus 120 may search for the UE 110 that is recognized inside a vehicle (S320).

The wireless power transmission control apparatus 120 may use wireless communication with the UE 110 to search for a UE and the wireless communication may be any one of Bluetooth communication, WiFi communication, and NFC communication.

For example, when the wireless communication used by the wireless power transmission control apparatus 120 is WiFi communication, a service set identifier (hereinafter, referred to as a “SSID”) generated from the UE 110. The SSID may be a unique identifier transmitted through a wireless LAN and may use MACs of the UE 110 as different identifiers for each UE.

When the wireless power transmission control apparatus 120 does not retrieve a plurality of identifiers (No of S320), the wireless power transmission control apparatus 120 may control whether the wireless power transmitter is activated using the predetermined charging activation indicator that is configured for each identifier and stored in a memory as described with reference to FIG. 1 (S360).

In this case, when the charging activation indicator of an identifier corresponding to the UE 110, wireless communication of which is connected to the wireless power transmission control apparatus 120, is not stored, i.e., when charging activation information configured to corresponding to the identifier of the UE 10, wireless communication of which is connected, is not present (No of S340), a charging activation indicator may be input from a user (S350). For example, charging activation information may be configured through selection of a predetermined menu included in the head unit but this is merely an embodiment and, as another example, a user may remotely configure charging activation information through selection of a predetermined application installed in a UE with a wireless power receiver installed therein.

When the wireless power transmission control apparatus 120 retrieves a plurality of identifies (Yes of S320), the wireless power transmission control apparatus 120 may connect wireless communication to the UE 110 that is the most recently connected (S330). In general, wireless communication may not connect a plurality of devices at tone time using a point-to-point communication method and may connect wireless communication to a UE that is the most recently connected UE among a plurality of identifiers.

The wireless power transmission control apparatus 120 may control whether the wireless power transmitter is activated using the charging activation indicator configured for the identifier using the identifier of the UE 110, wireless communication of which is mostly recently connected (S360).

When the charging activation indicator stores information indicated to deactivate the wireless power transmitter (No of S360), the wireless power transmission control apparatus 120 may control the wireless power transmitter to be activated and may select a next available identifier except for a first priority among the plurality of identifiers (S370) to check whether charging activation information preconfigured for the next available identifier is stored.

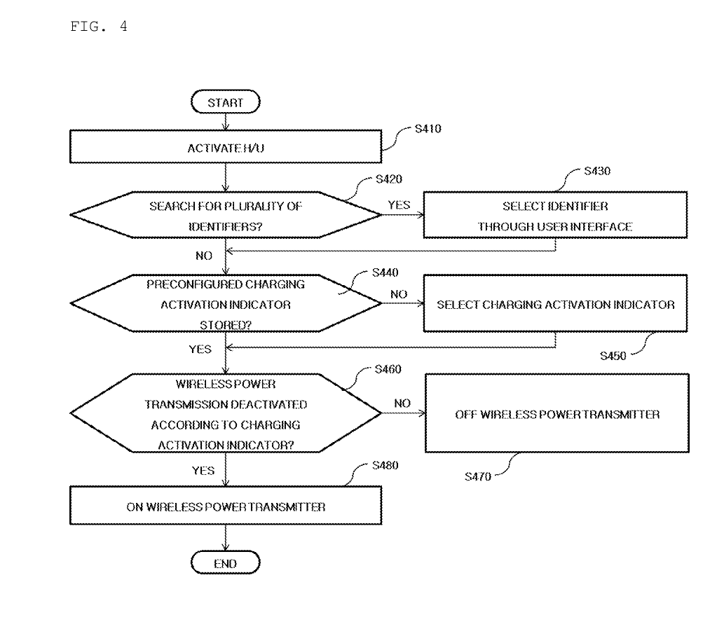

FIG. 4 is a flowchart for explanation of a method of recognizing a wireless power reception apparatus according to an embodiment.

Referring to FIG. 4, a method of selecting the UE 100, wireless communication of which is to be connected, among a plurality of identifiers when the wireless power transmission control apparatus 120 retrieves the plurality of identifiers may be different from in FIG. 2 in terms of some points.

When the wireless power transmission control apparatus 120 retrieves the plurality of identifiers (S420), the wireless power transmission control apparatus 120 may provide a identifier list of a plurality of retrieved UEs (e.g., the device registration selection image described with reference to FIG. 1) to allow a user to select an identifier of a UE, wireless communication of which is to be connected.

Then, the wireless power transmission control apparatus 120 may connect wireless communication to the UE selected from the user and may control whether the wireless power transmitter is activated using a charging activation indicator preconfigured to corresponding to an identifier of the UE, wireless communication of which is connected.

As another example, when the wireless power transmission control apparatus 120 retrieves a plurality of identifiers, the wireless power transmission control apparatus 120 may automatically determine a UE, wireless communication of which is to be connected, according to priority that is pre-stored in a memory.

For example, priority may be automatically configured by the wireless power transmission control apparatus 120 based on statistics information on the number of times that wireless communication is connected to perform wireless charging for a unit time (or hour) for each UE. As another example, the priority may be determined in the order from a UE, wireless communication of which is the most recently connected to perform wireless charging. As another example, the priority may also be determined in the order from a UE with a largest charging amount for a unit time. To this end, the wireless power transmission control apparatus 120 may collect statistics information on a wireless charging amount for a unit time for each UE.

The wireless power transmission control apparatus 120 may display the collected statistics information through a predetermined user interface screen and a user may directly select priority for each UE according to the displayed statistics information.

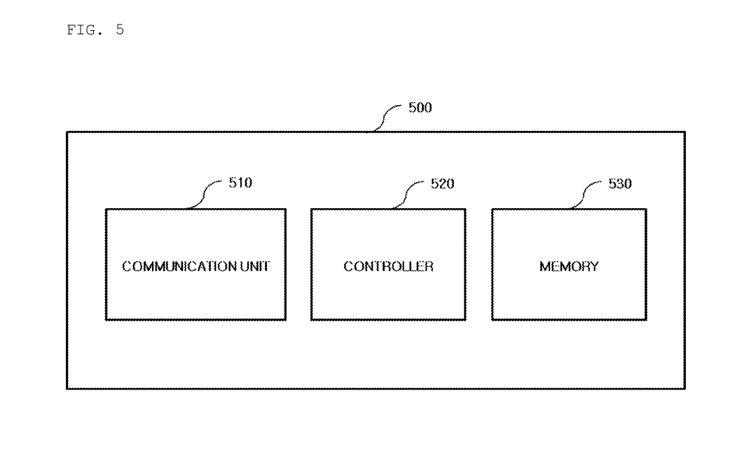

FIG. 5 is a diagram for explanation of a configuration of a wireless power transmission control apparatus according to an embodiment.

Referring to FIG. 5, a wireless power transmission control apparatus 500 may include a communication unit 510, a controller 520, and a memory 530.

Components shown in FIG. 5 are not necessary and, thus, greater or fewer components than in FIG. 5 may configure the wireless power transmission control apparatus 500.

Hereinafter, the components are described in detail.

The communication unit 510 may exchange a signal and data with a UE including a wireless power receiver configuring a wireless charging system. In addition, the communication unit 510 may exchange a signal and data of a wireless power transmitter through vehicle communication.

The controller 520 may perform data processing and calculation for control of an overall operation of the wireless power transmission control apparatus 500 and, according to an embodiment, the controller 520 may control power transmission stoppage according to power transmission stoppage determination.

According to an embodiment, when a plurality of identifiers is received, the controller 520 may connect wireless communication to a first wireless power receiver corresponding to a pre-stored first identifier among the plurality of identifiers and may control whether the wireless power transmitter is activated according to a charging activation indicator configured for the first identifier.

The memory 530 may collectively refer to a storage space and/or a storage region for storing a predetermined program code for control of an overall operation of the wireless power transmission control apparatus 500 and input/output data, etc. when an operation based on the program code is performed, and may be provided in the form of an electrically erasable and programmable read only memory (EEPROM), a flash memory (FM), a hard disk drive, or the like.

The method according to the aforementioned embodiments can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. and include the form of a carrier wave (e.g. transmission through the Internet).

The computer readable recording medium can also be distributed over network coupled computer systems so that the computer readable code is stored and executed in a distributed fashion. Also, functional programs, code, and code segments for accomplishing the embodiments can be easily construed by programmers skilled in the art to which the embodiments pertain.

It will be apparent to those skilled in the art that various modifications and variations can be made in the embodiments without departing from the spirit or scope of the embodiments.

Thus, it is intended that the embodiments cover the modifications and variations of embodiments provided they come within the scope of the appended claims and their equivalents.

### INDUSTRIAL APPLICABILITY

A wireless power transmission control method according to an embodiment may be used in a wireless power transmitter for transmitting a power signal to a plurality of wireless power receivers.

### SEQUENCE LIST TEXT

110: UE

120: wireless power transmission control apparatus

130: wireless power transmitter

500: wireless power transmission control apparatus

510: communication unit

520: controller

530: memory

1. A wireless power transmission control method comprising:
searching for devices through an identifier received using wireless communication;
selecting an identifier to which power is wirelessly transmitted among identifiers of the retrieved devices; and
controlling and determining whether a wireless power transmitter is activated, according to a charging activation indicator configured to correspond to the selected identifier.

2. The wireless power transmission control method of claim 1, wherein the selecting includes selecting the identifier of the device based on pre-collected wireless charging history information or through a user interface.

3. The wireless power transmission control method of claim 2, wherein the selecting includes, when the identifier is not retrieved in a plural number, selecting the retrieved identifier as the identifier to which power is wirelessly transmitted.

4. The wireless power transmission control method of claim 2, further comprising:
when the charging activation indicator is not stored, receiving the charging activation indicator; and
storing the charging activation indicator corresponding to the selected first identifier.

5. The wireless power transmission control method of claim 2, wherein the selecting includes, when the identifier is retrieved in a plural number, selecting the identifier according to pre-stored priority based on the wireless charging history information.

6. The wireless power transmission control method of claim 5, wherein the priority is configured in the order from a device with the largest number of times that the wireless communication is connected for a unit time.

7. The wireless power transmission control method of claim 5, wherein the priority is configured in the order from a device corresponding to the identifier that is the most recently selected.

8. The wireless power transmission control method of claim 2, wherein the searching includes, when the retrieved device is not present, maintaining the wireless power transmitter in a deactivated state or deactivating a pre-activated wireless power transmitter.

9. The wireless power transmission control method of claim 2, wherein the wireless communication is Bluetooth communication or wireless LAN communication.

10. A wireless power transmission control apparatus comprising:
a communication unit configured to receive an identifier from a device; and
a controller configured to select an identifier to which power is wirelessly transmitted among retrieved identifiers of the device and to determine whether a wireless power transmitter is activated according to a charging activation indicator configured to correspond to the selected identifier,
wherein the controller selects the identifier of the device based on pre-collected wireless charging history information or through a user interface.

11. The wireless power transmission control apparatus of claim 10, wherein, when the identifier is not retrieved in a plural number, the controller selects the retrieved identifier as the identifier to which power is wirelessly transmitted.

12. The wireless power transmission control apparatus of claim 10, further comprising:
an input unit configured to, when the charging activation indicator is not stored in a memory, receive the charging activation indicator; and
a memory configured to store the charging activation indicator corresponding to the selected first identifier.

13. The wireless power transmission control apparatus of claim 10, wherein, when the identifier is retrieved in a plural number, the controller selects the identifier according to pre-stored priority based on the wireless charging history information.

14. The wireless power transmission control apparatus of claim 13, wherein the priority is configured in the order from a device with the largest number of times that the wireless communication is connected for a unit time.

15. The wireless power transmission control apparatus of claim 13, wherein the priority is configured in the order from a device corresponding to the identifier that is the most recently selected.

16. The wireless power transmission control apparatus of claim 10, wherein, when the retrieved device is not present, the controller maintains the wireless power transmitter in a deactivated state or deactivates a pre-activated wireless power transmitter.

17. The wireless power transmission control apparatus of claim 10, wherein the wireless communication is Bluetooth communication or wireless LAN communication.

18. (canceled)
